(19) United States
(12) Patent Application Publication
(10) Pub. No.: US 2020/0386979 A1
(43) Pub. Date: Dec. 10, 2020

(54) BINOCULARS AND METHOD FOR MANUFACTURING SAME

(71) Applicant: TAMRON CO., LTD., Saitama-shi, Saitama (JP)

(72) Inventor: Masamitsu Hyodo, Saitama-shi, Saitama (JP)

(73) Assignee: TAMRON CO., LTD., Saitama-shi, Saitama (JP)

(21) Appl. No.: 16/618,865

(22) PCT Filed: Dec. 12, 2017
(86) PCT No.: PCT/JP2017/044533

§ 371 Date: Dec. 3, 2019

(51) Int. Cl. G02B 23/02; G01S 17/36; G01S 7/497

(52) U.S. Cl. CPC G02B 23/02; G01S 7/497; G01S 17/36

(57) ABSTRACT

Binoculars including a range finding function capable of enabling the correction of image shake over a broad range are provided. The present invention is a binocular (1) having: a binocular body 2, objective lens systems (4), eyepiece lens system (6), a pair of shake compensation lens systems (8) for stabilizing images, lens actuators (10) for driving shake compensation lens systems, a shake detection sensor (12), a control device (14) for controlling the lens actuators, a laser light source (16) for emitting laser light from the first objective lens system through a first shake compensation lens system, a light receiving element (22) for receiving laser light reflected by an observed object through a second objective lens system and second shake compensation lens system, and a computing device (2) for calculating the distance to an observed object based on laser light received by a light receiving element.

The present invention pertains to binoculars, and in particular to binoculars comprising a function for measuring the distance to an observed subject, and a method for manufacturing same.

### BACKGROUND ART

A laser range finder is set forth in Published Unexamined Japanese Patent Application 2004-101342 (Patent Document 1). This laser range finder has binocular optics, wherein a pair of erect prisms are disposed between a pair of objective lenses and a pair of eyepiece lenses, and a transmitting portion for emitting laser light irradiates laser light onto a target object through one of the erect prisms and one of the objective lenses. Laser light reflected by the target object is received through the other erect prism by a receiving portion. A computation means computes the distance to the target object by measuring time with a measurement means, starting when laser light is emitted by the transmitting portion, until it is received by the receiving portion, and a computation means computes the distance to an observed object based on this time. At the same time, a pair of erect prisms is supported by a single gimbal, and is attitude controlled by an antivibration means so as to be fixed relative to an inertial frame.

### PRIOR ART REFERENCES

### Patent Documents

### Patent Document 1: JP 2004-101342 A1

### SUMMARY OF THE INVENTION

### Problems the Invention Seeks to Resolve

In the Patent Document 1 invention, however, blurring of the target object image is compensated by driving an erect prism disposed in the optics, producing problems of restricted range of ability to compensate image shake and accuracy of compensation. Also, in the Patent Document 1 invention, a pair of erect prisms is affixed to a single gimbal, and blurring of the target object image is compensated by driving this gimbal, creating the problem that image shake is difficult to compensate with high accuracy. I.e., in the gimbal structure of the Patent Document 1 invention, the transmitting laser optical path and receiving laser optical path cannot be precisely controlled, and even if laser transmission is accurate, the laser light may not be accurately received, producing measurement errors such that sufficient range finding performance cannot be obtained.

The present invention thus has the object of providing an anti-vibration function and manufacturing method for same, whereby in order to further improve range finding accuracy by the two functions of range finding by laser transmission and receiving and image shake compensation by anti-vibration means, anti-vibration control is performed independently in the left and right lenses to optimize the laser light path, thereby achieving improvement in range finding.

### Means for Resolving Problem

To resolve the above-described problems, the present invention comprises: a binocular body; a pair of objective lens systems; a pair of eyepiece lens systems for respectively enlarging images formed by each of the pair of objective lenses; a pair of shake compensation lens systems disposed on an optical path between the objective lens system and the eyepiece lens systems, for respectively stabilizing images formed by each of the pair of objective lens systems; a shake detection sensor for detecting vibration of the binocular body; a first lens actuator for driving the first shake compensation lens system among shake compensation lens systems, within a plane normal to the optical axis; a second lens actuator for driving the second shake compensation lens system among the shake compensation lens systems, within a plane normal to the optical axis; and a control device for independently controlling the first and second lens actuators based on a detection signal from the shake detection sensor; and further comprising a laser light source for emitting laser light through a first shake compensation lens systems for range finding from a first objective lens system among the objective lens system; a light receiving element for receiving laser light emitted by the first objective lens system and reflected by an observed object, via a second objective lens system among the objective lens systems, and via a second shake compensation lens system; and a computing device for calculating the distance to an observed object based on laser light received by the light receiving element: whereby the control device controls the first and second lens actuators so that the positions in the vertical direction of images formed by each of the first and second objective lens systems are synchronized.

In the invention thus constituted, the image formed by the pair of objective lenses attached to the body of the binoculars is expanded by a pair of eyepiece lenses. A pair of shake compensation lens systems for stabilizing images is disposed on the optical path between the objective lens system and the eyepiece lens system, and these shake compensation lens systems are respectively driven by first and second lens actuators within a plane normal to the optical axis. Vibration in the binocular body is detected by a shake detection sensor, and a control device controls the lens actuators to stabilize the image based on the detected detection signal. At the same time, a laser light source built into the binocular body causes laser light from the first objective lens system to be emitted through the first shake compensation lens system. Laser light emitted from the first objective lens system and reflected from the observed object is received by a light receiving element through a second objective lens system and a second shake compensation lens system, and a computing device calculates distance to the observed object based on the received laser light.

In the invention thus constituted, image shaking is compensated by driving a pair of shake compensation lens systems disposed on the optical path between an objective lens system and a eyepiece lens system within a plane normal to the optical path, therefore image shaking can be compensated with good accuracy over a broad range. Also, the first and second lens actuators are controlled so that the positions in the vertical direction of each image respectively formed by the first and second objective lens systems are synchronized, therefore the distance to the observed object can be accurately measured.

The present invention is a manufacturing method for binoculars comprising a function for measuring distance to an observed object, having: a step for preparing a binocular body; a step for attaching to the binocular body a pair of objective lenses, a pair of eyepiece lenses, a pair of shake compensation lens systems, lens actuators to drive these shake compensation lens systems, a shake detection sensor, a control device for controlling the lens actuators, a laser light source for emitting laser light for range finding, and a computing device for calculating distance to an observed object based on received laser light; a step for adjusting control parameters of the control device so that each of the pair of shake compensation lens systems is driven in sync; and a step for storing adjusted control parameters in the control device memory.

### Effect of the Invention

Using the binoculars and manufacturing method for same of the present invention, image shaking can be compensated with high accuracy, and range finding accuracy can be improved.

### BRIEF DESCRIPTION OF FIGURES

FIG. 1 A cross section of binoculars according to an embodiment of the invention.

FIG. 2 A diagram schematically showing an example of the output signal from a shake detection sensor in binoculars according to an embodiment of the invention.

FIG. 3 A diagram schematically showing the relationship between angular velocity, shake angle, and displacement of lens obtained based on the output of a shake detection signal in binoculars according to an embodiment of the invention.

FIG. 4 A flow chart showing the manufacturing procedure for binoculars according to an embodiment of the invention.

FIG. 5 A flow chart of lens actuator control in binoculars according to an embodiment of the invention.

FIG. 6 A diagram schematically showing emission of laser light from a laser light source for range finding and receiving of reflected light from an observed object in binoculars according to an embodiment of the invention.

### EMBODIMENTS OF THE INVENTION

Binoculars

Referring to the attached figures, we discuss binoculars according to an embodiment of the present invention.

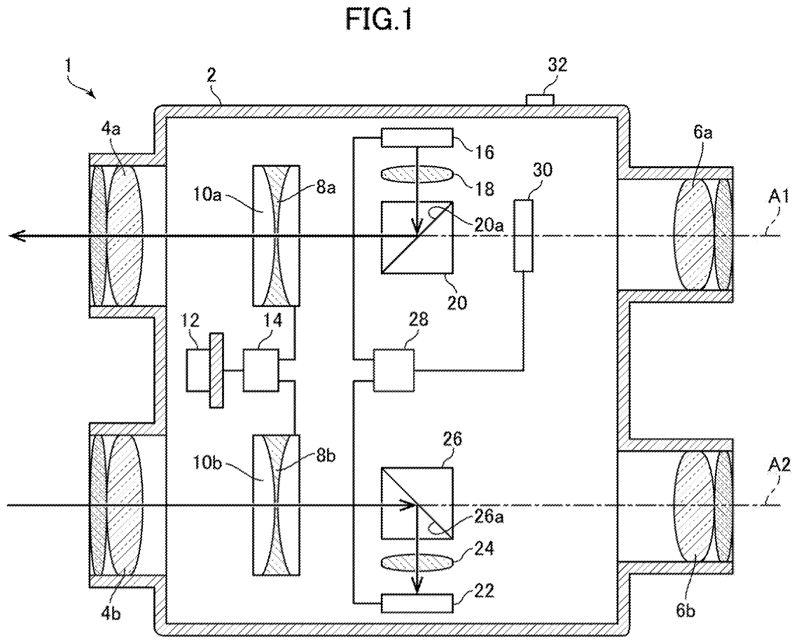

FIG. 1 is a cross section of binoculars according to an embodiment of the invention.

As shown in FIG. 1, binoculars 1 of the present embodiment have: a binocular body 2, a pair of objective lens systems 4a, 4b attached to this binocular body, a pair of eyepiece lens systems 6a, 6b attached to the binocular body 2, a pair of shake compensation lens systems 8a, 8b for stabilizing images formed by an objective lens system, lens actuators 10a, 10b for driving these shake compensation lens systems, a shake detection sensor 12 for detecting vibration of the binocular body 2, and a control device 14 for controlling the lens actuators based on the shake detection sensor 12 detection signal.

As shown in FIG. 1, the binocular body 2 is a metal case, on the front edge portion of which a pair of objective lens systems 4a, 4b is arrayed on the left and right, and on the rear edge of which a pair of eyepiece lens systems 6a, 6b is arrayed and attached on the left and right. The binocular body 2 is constituted to be approximately left-right symmetrical.

(Lens System)

The objective lens systems 4a, 4b are lens systems respectively attached to the front edge of binocular body 2, constituted to form an image of a target object. In the present embodiment, the objective lens systems 4a, 4b are each made up of two lenses, but an objective lens system may also be made up of one lens or three or more lenses. In addition, in the present embodiment, one of the objective lens systems 4a in the pair of objective lens systems 4a, 4b is constituted as a first objective lens system to emit laser light for range finding from a laser light source 16, while the other objective lens system 4b is constituted as a second objective lens to receive incident laser light for range finding from a target object.

The eyepiece lens systems 6a, 6b are lens systems respectively attached to the rear edge of the binocular body 2, and are disposed so that the eyepiece lens system 6a expands an image formed by the objective lens system 4a, whereas the eyepiece lens system 6b expands an image formed by the objective lens system 4b. In the present embodiment, the eyepiece lens systems 6a, 6b are each made up of two lenses, but an eyepiece lens system may also be made up of one lens or three or more lenses.

(Shake Compensation Mechanism)

The shake compensation lens systems 8a, 8b are disposed inside the binocular body 2 on the optical path between the objective lens system and the eyepiece lens system, and of these the shake compensation lens system 8a is disposed on the optical path between the objective lens system 4a and the eyepiece lens system 6a, while the shake compensation lens system 8b is disposed on the optical path between the objective lens system 4b and the eyepiece lens system 6b. Also, in the present embodiment the shake compensation lens systems 8a, 8b are each constituted by a single lens, but a shake compensation lens system could also be constituted by two or more lenses.

The lens actuators 10a, 10b respectively support the shake compensation lens systems 8a, 8b, and are constituted to cause these to move translationally in a plane normal to optical axes A1, A2. In the present embodiment, the two lens actuators 10a, 10b are constituted to separately hold the two shake compensation lens systems 8a, 8b, and to be independently drivable. In the binoculars 1 of the present embodiment, the optical path is corrected and the formed image stabilized by causing shake compensation lens systems 8a, 8b to respectively move translationally within a plane normal to the optical axis in response to binocular body 2 vibration detected by the shake detection sensor 12.

Specifically, lens actuators 10a, 10b respectively comprise: a moving frame to which shake compensation lens systems are attached, a support means for supporting this moving frame relative to a fixed portion so that it can move translationally, and multiple linear motors for driving the moving frame relative to a fixed portion (the above not shown). By so doing, drive force is generated by sourcing current to each of the respective linear motor drive coils (not shown), and the moving frame is translationally moved relative to the fixed portion. Thus in the present embodiment a voice coil type of actuator using multiple linear motors is used as the lens actuator, but other desired forms of actuators may be used as the lens actuator.

In order to detect vibration in the binocular body 2, the shake detection sensor 12 is a sensor attached to the interior of the binocular body 2, disposed approximately on the binocular body 2 axis of symmetry, which is formed to be approximately left-right symmetrical. I.e., each shake compensation lens system 8a, 8b is disposed at positions symmetrical relative to the shake detection sensor 12, on both sides of the shake detection sensor 12. Also, in the present embodiment the shake detection sensor 12 comprises two piezoelectric vibrating gyroscopes (not shown). These piezoelectric vibrating gyroscopes detect the respective vibration angular velocities in the pitch and yaw directions of the binocular body 2, and the vibration angle in each direction is calculated by integrating the electrical signal indicating angular velocity over time. In response to the calculated vibration angle, the shake compensation lens systems 8a, 8b are translationally moved so as to deflect the optical axis and counteract the vibration angle, thereby stabilizing the formed image. Processing of the signal detected by the shake detection sensor 12 is discussed below.

The control device 14 is constituted to respectively control the lens actuators 10a, 10b based on the signal detected by the shake detection sensor 12. Specifically, the control device 14 may comprise a microprocessor, memory, A/D converter, D/A converter, interface circuit, lens actuator drive circuit, and software used to operate these (the above not shown). Also, the control device 14 time-integrates the signal detected by the shake detection sensor 12 to calculate vibration angle in the pitch and yaw directions. Next, a calculation is made of the positions to which the shake compensation lens systems 8a, 8b must be respectively moved to counteract the calculated vibration angles in each direction. At the same time, signals indicating the current positions of each shake compensation lens systems 8a, 8b are input from each of the lens actuators 10a, 10b. The control device 14 is constituted so that current sourced to the lens actuator linear motor coil (not shown) is set and output by multiplying the deviation between the position to which the shake compensation lens system is to be moved and its current position by a predetermined feedback gain.

In the binoculars 1 of the present embodiment, a shake detection sensor 12 detects vibration of the binocular body 2, a control device 14 controls lens actuators 10a, 10b based on this vibration, and shake compensation lens systems 8a, 8b are moved within a plane normal to the optical axis. The image formed by the objective lens systems 4a, 4b is thus stabilized, enabling a user to see a stabilized image of an observed object.

(Distance Measurement Mechanism)

In addition, the binoculars 1 of the present embodiment have: a laser light source 16 for causing laser light for range finding to be emitted from one of the objective lens systems, a projection lens 18, a light projection splitting prism 20, a light receiving element 22 for receiving laser light reflected from an observed object, a light receiving lens 24, a light receiving splitting prism 26, a computing device 28 for calculating the distance to an observed object based on laser light received by the light receiving element 22, a display device 30 showing the calculated distance, and a range finding switch 32.

The laser light source 16 is a laser diode disposed on the side of an optical axis A1 which connects objective lens system 4a and eyepiece lens system 6a, and is constituted to emit infrared laser light for range finding. This laser light source 16 is constituted to emit laser light for measurement of the distance to an observed object in response to user manipulation of the range finding switch 32 placed on the binocular body 2. As shown in FIG. 1, the laser light source 16 is disposed to emit laser light in a direction normal to optical axis A1: this laser light is incident, through the projection lens 18, on the light projection splitting prism 20.

The light projection splitting prism 20 is a cuboid disposed on the optical axis A1 connecting the objective lens system 4a and the eyepiece lens system 6a. A half mirror surface 20a is formed on a plane connecting opposing corners in the top plane view of this light projection splitting prism 20. This half mirror surface 20a is constituted to reflect infrared light and transmit visible light. Therefore visible light incident from the objective lens system 4a and passing through the shake compensation lens system 8a passes unimpeded through the light projection splitting prism 20 to reach the eyepiece lens system 6a. On the other hand, infrared light emitted from the laser light source 16 is reflected at the half mirror surface 20a, where its optical path is bent 90° and made parallel to optical axis A1. By so doing the infrared light emitted from the laser light source 16 is reflected by the half mirror surface 20a and emitted through the shake compensation lens system 8a from the objective lens system 4a toward the observed object.

The light receiving element 22 is a charge coupled device disposed on the side of optical axis A2 connecting the objective lens system 4b and the eyepiece lens system 6b, and is constituted to receive infrared laser light reflected by an observed object. As shown in FIG. 1, the light receiving element 22 is constituted to receive light incident along the optical axis A2 and reflected by the light receiving splitting prism 26.

The splitting prism for the light receiving splitting prism 26 is a cuboid disposed on the optical axis A2 connecting the objective lens system 4b and the eyepiece lens system 6b. A half mirror surface 26a is formed on the plane connecting the opposing corners in the top plan view of this light receiving splitting prism 26. This half mirror surface 26a is constituted to reflect infrared light and transmit visible light. Therefore visible light incident from the objective lens system 4b along optical axis A2 and passing through the shake compensation lens system 8b passes unimpeded through the light receiving splitting prism 26 and reaches the eyepiece lens system 6b. On the other hand, infrared light reflected by the observed object is reflected at the half mirror surface 26a, and the optical path is bent in a direction normal to optical axis A2. Infrared light reflected by the observed object and incident from the objective lens system 4b is thus reflected by the half mirror surface 26a and made incident through the light receiving lens 24 on the light receiving element 22.

The computing device 28 is constituted so that signals pertaining to infrared laser light emitted by the laser light source 16, and to infrared laser light reflected by an observed object and received by a light receiving element 22 are input thereto, and the distance to the observed object is calculated based on the phase difference between these laser lights. Specifically, the computing device 28 may comprise a microprocessor, memory, interface circuit, and software to operate same (the above not shown). The microprocessor, memory, and the like constituting the computing device 28 may also be shared with the control device 14, so that the control device 14 and computing device 28 are comprised of a single microprocessor and memory, etc. The computing device 28 may also be constituted so that the distance to the observed object is calculated based on the time after laser light is emitted from the laser light source 16 until reflected light is received by the light receiving element 22.

The display device 30 is an LCD panel disposed on the optical axis A1 between the light projection splitting prism 20 and the eyepiece lens system 6a, and is constituted to display the distance to an observed object calculated in the computing device 28. This LCD panel is transparent during normal use, and does not block a user's view. When a user activates the range finding function, the distance calculated by the computing device 28 is displayed in a corner of the LCD panel, and the distance to an observed object is indicated within the viewfield of a user observing through the binoculars 1. Thus the present invention is constituted so that a measured distance is displayed within a finder, but it is also possible to comprise the present invention by disposing the display device 30 on the outer surface of a binocular body 2.

By thus constituting the binoculars 1 of the present embodiment, when a user manipulates the range finding switch 32, a laser light source 16 built into the binocular body 2 emits light, and emitted laser light is projected onto an observed object through the projection lens 18, the light projection splitting prism 20, the shake compensation lens system 8a, and the objective lens system 4a. Projected laser light is reflected by an observed object and received by the light receiving element 22 through the objective lens system 4b, the shake compensation lens system 8b, the light receiving splitting prism 26, and the light receiving lens 24. The computing device 28 built into the binocular body calculates distance from the binoculars 1 to the observed object based on the phase difference between laser light emitted from the laser light source 16 and laser light received by the light receiving element 22. The calculated distance to the observed object is displayed by the display device 30, and indicated to a user through the eyepiece lens system 6a.

(Controls Pertaining to Shake Compensation)

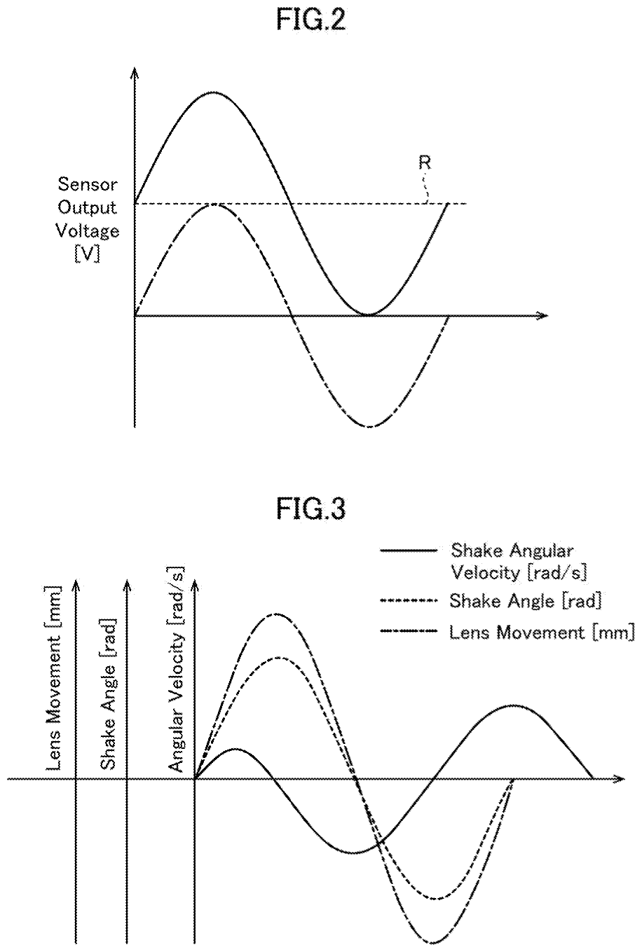

Next, referring to FIGS. 2 and 3, we explain processing in a control device 14 of a signal detected by the shake detection sensor 12.

FIG. 2 is a diagram schematically indicating an example of an output signal from a shake detection sensor 12. FIG. 3 is a diagram schematically indicating the relationship between angular velocity, shake angle, and displacement of lens, which is obtained based on the output signal from the shake detection sensor 12.

As described above, in the present embodiment a piezoelectric vibrating gyroscope is used as the shake detection sensor 12. In general, the output signal from the piezoelectric vibrating gyroscope is output as a signal which fluctuates around a predetermined reference voltage, as shown by the solid line in FIG. 2. I.e., when angular velocity is zero, the output signal from shake detection sensor 12 becomes the predetermined reference voltage R shown by the dotted line in FIG. 2, and the output voltage fluctuates around the reference voltage R in response to the angular velocity acting on the shake detection sensor 12. Therefore a voltage signal offset by the reference voltage R, such as that shown by the solid line in FIG. 2, is input to an A/D converter (not shown) furnished in the control device 14.

In the control device 14, a DC (direct current) component corresponding to reference voltage R is subtracted from the input voltage signal to extract the AC (alternating current) component shown by the dot-and-dash line in FIG. 2. Specifically, the input signal from shake detection sensor 12 is converted to digital data by the control device 14 A/D converter (not shown), and the DC component is removed from the converted digital data by numerical calculation. Note that in image anti-vibration control in an image-capturing camera or the like, the 0.1 Hz and below signal component is normally treated as a DC component and removed by a high pass filter to extract the AC component, but in the present embodiment stability is improved by using an even lower cut off frequency.

Next, referring to FIG. 3, signal processing in the control device 14 is explained.

As described above, an angular velocity signal waveform containing a DC component, as shown by the solid line in FIG. 2, is input to the control device 14 A/D converter (not shown), and after converting to digital data, the DC component is removed. One example of an angular velocity signal from which this DC component is removed is shown by the solid line in FIG. 3. Image anti-vibration compensation control in the binoculars 1 of the present embodiment stabilizes formed images by deflecting the optical axis using shake compensation lens systems 8a and 8b to cancel the shake angle in the pitch direction and yaw direction of the binocular body 2. It is therefore necessary to generate a shake angle signal based on the angular velocity signal shown by the solid line in FIG. 3.

Specifically, the microprocessor in control device 14 (not shown) numerically time-integrates the angular velocity signal shown by the solid line in FIG. 3 to generate the shake angle signal shown by the dotted line in FIG. 3. The shake detection sensor 12 is constituted to detect the shake angle velocity in the pitch direction and yaw directions, and these angular velocity signals are respectively integrated to calculate the shake angles in the pitch and yaw directions. Here, if the DC component of the integrated angular velocity signal has not been sufficiently removed, the DC component will be added by the time integration, causing a large offset in the shake angle. In the present embodiment, the DC component is removed at a low cut off frequency, therefore the shake angle signal can be obtained with good accuracy.

Based on the calculated shake angle, the control device 14 calculates the target positions (displacement from the initial position) able to counteract this for shake compensation lens systems 8a, 8b. Note that in the present embodiment, the displacement of shake compensation lens system 8a and 8b (target positions) capable of counteracting the shake angle of the binocular body 2 is approximately proportional to the shake angle of the binocular body 2, so the waveform of the shake compensation lens systems 8a, 8b displacement shown by the dot and dash line in FIG. 3 is essentially similar to the waveform of the shake angle shown by the dotted line. In actuality the shake angles in the pitch direction and yaw direction are respectively calculated, and a target position X1 in the horizontal direction of the shake compensation lens systems 8a, 8b for counteracting the shake angle in the pitch direction, and the target position Y1 in the perpendicular direction of the shake compensation lens systems 8a, 8b for counteracting the shake angle in the yaw direction are respectively calculated.

The control device 14 sends a drive signal to lens actuators 10a, 10b, causing shake compensation lens systems 8a, 8b to translationally move to a target position in a plane normal to the optical axis, thereby deflecting optical axes A1, A2. By this means the shake angle is counteracted in each direction of the binocular body 2, stabilizing the formed image. I.e., the control device 14 controls the first and second lens actuators 10a, 10b so that positions in the vertical and horizontal directions of each image formed by the respective first objective lens system 4a and the second objective lens system 4b are synchronized. Also, in the present embodiment the two shake compensation lens systems 8a, 8b are independently controlled to stabilize the image. I.e., compared to a conventional gimbal structure, a linear actuator with a lens shift structure, which independently operates left and right optical axis correcting lenses, is able to obtain a high laser light path compensation capability.

First, lens actuators 10a, 10b detect the horizontal direction position X2 and vertical direction position Y2 of shake compensation lens systems 8a and 8b, outputting these detection signals as a time sequence to the control device 14. The control device 14 calculates signals X2, Y2 indicating the positions of shake compensation lens systems 8a, 8b input from the lens actuators 10a, 10b, and the deviations Rx (=X1−X2) and Ry (Y1−Y2) relative to the target positions X1, Y1 of the shake compensation lens systems 8a, 8b for counteracting image shake. The control device 14 sources current at a value obtained by multiplying these deviations Rx. Ry by a feedback gain to drive coils for lens actuators 10a, 10b. By repeating this control, the shake compensation lens systems 8a, 8b are moved so as to independently follow the target positions X1, Y1 set in response to vibration of the binocular body 2, thereby stabilizing the image.

(Manufacturing Method)

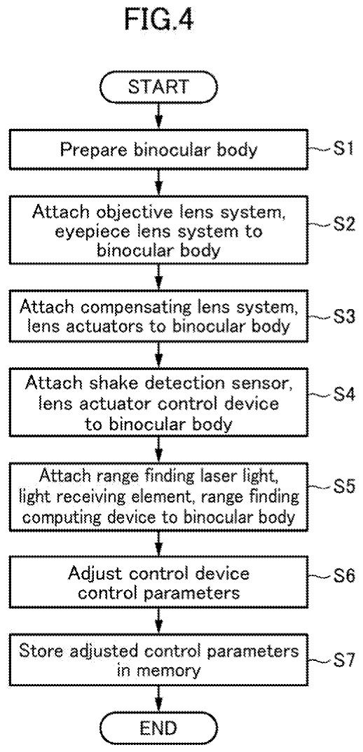

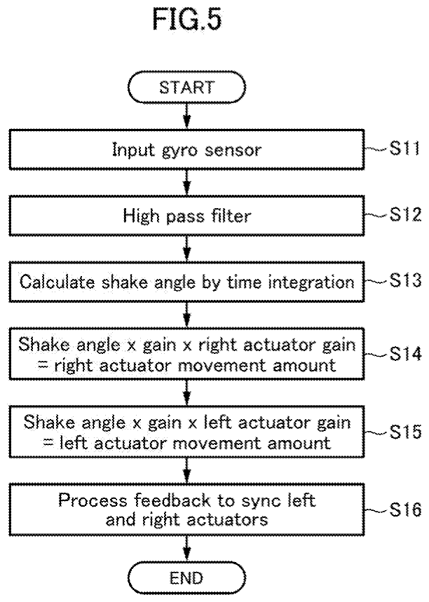

Next, referring to FIG. 4, a method of manufacturing binoculars according to an embodiment of the present invention is explained. FIG. 4 is a flow chart showing a procedure for manufacturing binoculars.

First, in step S of FIG. 4, components forming a binocular body 2 for binoculars 1 are prepared.

Next, in step S2, a pair of objective lens systems 4a, 4b and a pair of eyepiece lens systems 6a, 6b are attached to the prepared binocular body 2 component.

In step S3, lens actuators 10a, 10b, respectively supporting shake compensation lens systems 8a, 8b, are attached to the binocular body 2 component.

In addition, in step S4, a control device 14 for controlling shake detection sensor 12 and lens actuators 10a, 10b is attached to the binocular body 2 component.

In step S5, a laser light source 16 for emitting laser light for range finding, a light receiving element 22 for receiving laser light reflected by an observed object, and a computing device 20 for calculating the distance to an observed object based on the received laser light are attached to the binocular body 2 component. Moreover, a projection lens 18, light projection splitting prism 20, light receiving lens 24, light receiving splitting prism 26, and display device 30 are also attached to the binocular body 2 component. The process in steps S3-S5 is not particularly limited; any desired order may be determined as suitable for increasing manufacturing efficiency or component placement, etc.

Next, in step S6, the control parameters are adjusted for the control device 14 driving the pair of shake compensation lens systems 8a, 8b. Specifically, adjustments are made to minimize differences in left/right anti-vibration characteristics. Differences in anti-vibration characteristics include, for example, characteristics of the left and right shake compensation lens systems 8a, 8b themselves, left and right lens actuator 10a, 10b characteristics, left and right mechanical characteristics, and so forth. Taking into account preferably all characteristics of at least the lens actuators 10a, 10b, adjustments are made to minimize differences in left/right anti-vibration characteristics. Here, minimum means the state in which the positions of images respectively formed in the left and right lens systems are approximately synchronized. Note that synchronizing of positions in the vertical and horizontal directions may mean that positions in the vertical and horizontal directions are the same positions, or that positions in the vertical and horizontal directions in the optical axis of the image (lens system) are the same positions, the term may be used as appropriate, according to use.

For example, if the driving distance applied to each of the shake compensation lens systems 8a, 8b by lens actuators 10a and 10b when the same control parameter is output from control device 14 (i.e., when there is a difference in anti-vibration performance), the images formed on the left and right will not sync, and by extension it will not be possible to sync the optical paths between the transmit and receive sides of the laser light used to measure distance. In response, the left and right anti-vibration performances can be matched by adjusting control parameters so that the driving distance applied to the lens actuator with the greater driving distance is matched to the distance by which the other lens actuator is driven. By so doing, the difference in anti-vibration performance due to lens actuators 10a, 10b can be minimized so that images formed on the left and right can be synchronized, and the optical paths of laser light used for range finding can be synchronized.

Finally, in step S7, the accuracy of binocular 1 range finding during use by a user can be improved by storing the adjustment values as an adjustment table in control device 14 memory (not shown) in step S6.

Adjustment of the control parameters in step S6 is preferably performed while confirming left and right images with a dedicated test device to check the performance differences thereof. Regarding anti-vibration performance, synchronization of left and right images is important, as described above, and adjustments are performed not to maximize the performance of individual items, but so that differences in the left/right anti-vibration performance as a whole are minimized, and those adjusted values are stored in memory in step S7 (not shown).

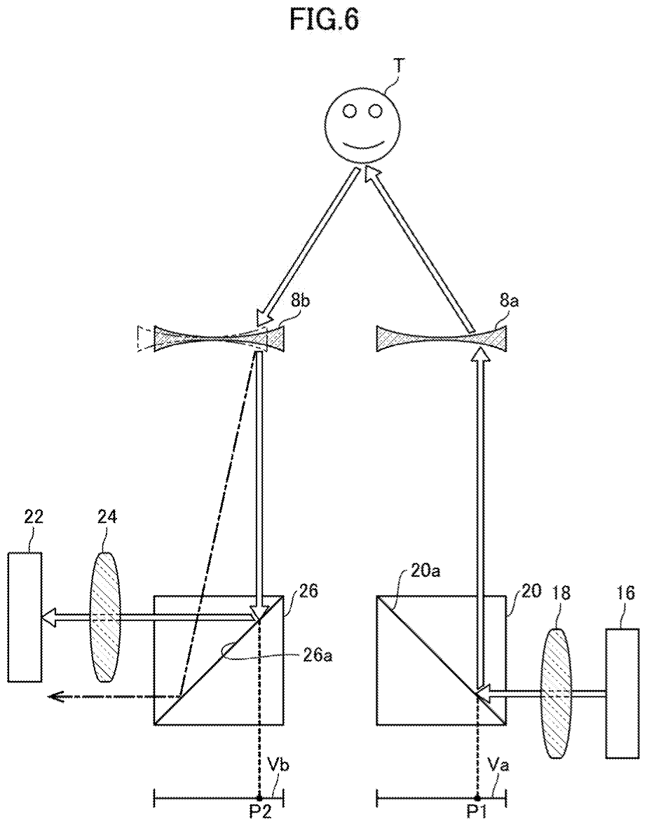

Next, referring to FIGS. 5 and 6, the operation of binoculars 1 according to an embodiment of the present invention is explained.

FIG. 5 is a flow chart of the control of lens actuators 10a, 10b in binoculars 1 of the present invention. FIG. 6 is a diagram schematically depicting emission of laser light from a laser light source 16 for measuring distance, and receiving of reflected light from an observed object, in binoculars 1 of the present embodiment. Note that the flow chart shown in FIG. 5 depicts processing repeatedly executed at a predetermined time interval while the shake compensation function is operating in the binoculars 1.

First, in step S11 of FIG. 5, a pitch and yaw direction shake angle detection signal is input to the control device 14 from the shake detection sensor 12, which is a piezoelectric gyro sensor. The two lens actuators 10a, 10b are thus controlled based on a single shake detection sensor 12 detection signal, so there will be no offset in the movement of each lens actuator caused by this detection signal.

Next, in step S12, a bypass filter (not shown) is applied to the detection signal input from the shake detection sensor 12 to the control device 14, removing the DC a component in the detection signal. I.e., the signal shown by the solid line in FIG. 2 is converted to the signal shown by the dot and dash line.

In step S13, the shake angle of the binocular body 2 is calculated by performing a time integration of the shake angle velocity detection signal with the DC component removed. I.e., the signal shown by the solid line in FIG. 3 is converted to the signal shown by dotted line.

In step S14, the target position X (displacement from the initial position) for the right side lens actuator 10a is calculated based on the yaw direction shake angle calculated in step S13, and the target position Y1 (displacement from the initial position) is calculated based on the pitch direction shake angle. I.e., the signal shown by the dotted line in FIG. 3 is converted to the signal shown by the dot and dash line. Specifically, the calculated shake angle is multiplied by the proportionality factor (gain) between the shake angle and the displacement of the shake compensation lens system and the adjustment value for the right side lens actuator 10a stored as a control parameter in memory (not shown) in step S7 of the flow chart shown in FIG. 4.

In step S15, similarly, the target position X1 (displacement from the initial position) for the left side lens actuator 10b is calculated based on the yaw direction shake angle calculated in step S13, and the target position Y1 (displacement from the initial position) is calculated based on the pitch direction shake angle. Specifically, the calculated shake angle is multiplied by the proportionality factor (gain) between the shake angle and the displacement of the shake compensation lens system and the adjustment value for the left side lens actuator 10b stored as a control parameter in memory (not shown).

Here, as the adjustment values for the left and right sides stored in memory (not shown) are normally not the same, the X1 and Y target positions relative to the right side lens actuator 10a and the X1 and Y1 target positions relative to the left side lens actuator 10b, calculated in step S14, are slightly different values. Thus individual differences between lens actuators and the like are offset by providing different target positions X1, Y1 to the right and left side lens actuators.

Next, in step S16, the control device 14, using the target positions X1, Y1 respectively set in step S14 and S15, calculates the manipulating variable of each of the lens actuators 10a, 10b (the current value to be sourced to the lens actuator drive coils (not shown)) to control the lens actuators. By so doing, the two lens actuators 10a, 10b are respectively driven, images are synchronized after correction by left and right shake compensation lens systems 8a, 8b, and the left and right sides become sufficiently matched.

Next, referring to FIG. 6, we explain a method for measuring distance using the binoculars 1 in an embodiment of the present invention. FIG. 6 shows a cutout of only the portion pertaining to the range finding function with which the binoculars 1 of the present embodiment are provided.

First, a user measures the distance to an observed object T when the binoculars 1 are in use by manipulating the range finding switch 32 (FIG. 1) disposed on the binocular body 2 to turn on the range finding function. As a result, the laser light source 16 built into the binoculars 1 emits infrared laser light, and this laser light is emitted via projection lens 18, light projection splitting prism 20, shake compensation lens system 8a, and objective lens system 4a. Laser light is thus shone on an observed object T locate at a predetermined position within the visual field of the binoculars 1. This laser light illuminated position corresponds to position P1 within visual field Va in the right side objective lens system 4a. At this time, shake compensation lens systems 8a, 8b are driven in response to vibrations of the binoculars 1, and because image vibration is corrected, the user can easily fit the observed object T into the visual field of the binoculars 1. Also, because laser light for range finding is also illuminated through shake compensation lens system 8a, laser light is illuminated onto a position within a visual field corrected by the shake compensation lens system 8a. Therefore a user can easily illuminate (hit) an observed object T with laser light for range finding.

In addition, laser light shone on observed object T is reflected and returns to the binocular 1 objective lens systems 4a, 4b. Here the two shake compensation lens systems 8a, 8b are driven in sync, therefore laser light emitted from the objective lens system 4a and reflected and returned to the objective lens system 4b is refracted in the same way as when it was emitted, and forms an image at position P2 within the left side objective lens system 4b visual field Vb. This position P2 on the left side visual field Vb corresponds to the position P1 within the right side visual field Va into which laser light is emitted. I.e., laser light emitted from the right side objective lens system 4a, reflected, and returned to the left side objective lens system 4b returns to position P2 in left side visual field Vb, which is the same as the laser light emission position P1 in the right side visual field Va. Therefore the light receiving element 22 is capable of reliably receiving laser light reflected from an observed object T. Also, it is desirable to constitute the light receiving element 22 receiving reflected laser light so that it is capable of receiving only the laser light which returns to the vicinity of position P2 corresponding to position P1 of the laser light source 16 in the visual field; the light receiving element 22 may be constituted compactly.

In contrast, as shown in FIG. 6, if the right side shake compensation lens system 8a and left side correction lens system 8b are not sufficiently synced, laser light incident on the left side objective lens system 4b ends up returning to a different position within the visual field (a position not corresponding to the emitted position) from the emitted position. Thus with a compact light receiving element, returned laser light cannot be received with certainty. Even in these cases, a large light receiving element is needed to receiving laser light, increasing cost.

In addition, the computing device 28 calculates the distance from binoculars 1 to the observed object T based on the phase difference between the laser light emitted from the laser light source 16 and the laser light received by the light receiving element 22, then displays it on the display device 30. A user can see the measured distance within the visual field of the binoculars 1. In a binoculars 1 of the present embodiment of the invention, the accuracy of measured distances is improved approximately 20% by driving the two shake compensation lens systems 8a, 8b in sync.

Using the binoculars 1 of the present embodiment of the invention, image shake is compensated (FIG. 1) by driving the pair of shake compensation lens systems 8a, 8b disposed on an optical path between the objective lens systems 4a, 4b and the eyepiece lens systems a, 6b within a plane normal to optical axes A1, A2, therefore image shake can be accurately compensated over a broad range. Laser light emitted through the first shake compensation lens system 8a and reflected by an observed object is received by the light receiving element 22 via the second shake compensation lens system 8b. Therefore laser light for range finding can be reliably shone on an observed object T, and laser light reflected from the observed object T can be reliably received, so the distance to the observed object T can be accurately measured (FIG. 6).

In the binoculars 1 of the present embodiment, the lens actuators 10a, 10b separately hold the first and second shake compensation lens systems 8a, 8b and are independently driven, so the two shake compensation lens systems 8a, 8b can be independently driven. Hence images can be sufficiently synced after correction by each of the shake compensation lens systems 8a, 8b, and reflected laser light emitted from the laser light source 16 can be reliably received by the light receiving element 22.

In addition, with the binoculars 1 of the present embodiment, the computing device 28 calculates the distance to the observed object based on the phase difference between the laser light emitted by the laser light source 16 and the laser light received by the light receiving element 22, therefore the range finding is less susceptible to external disturbance and distance to an observed object can be accurately measured.

Using the binoculars 1 of the present embodiment, the laser light source 16 is constituted to emit laser light from a predetermined position P1 within the visual field Va of the first objective lens system 4a and, in the second objective lens system 4b visual field 4b, the light receiving element 22 is disposed to receive laser light incident at a position P2 corresponding to the laser light emitted position P1 within the visual field Va of the first objective lens system 4a. Therefore by driving the two shake compensation lens systems 8a, 8b in sufficient synchronization, laser light can be reliably received even when using a light receiving element 22 with a narrow light receiving range, thereby reducing the cost of the light receiving element 22.

Also, using binoculars 1 of the present embodiment, the first and second shake compensation lens systems 8a, 8b are disposed on both sides of the shake detection sensor 12 at positions symmetrical to the shake detection sensor 12. The shake detection sensor 12 is thus disposed at equal distances from the two shake compensation lens systems, and the shake angle offsets detected based on the shake detection sensor 12 are equal relative to the two shake compensation lens systems, so that driving the two shake compensation lens systems 8a, 8b can be easily synchronized.

Also, in the manufacturing method for the binoculars 1 of the present embodiment, control parameters for the control device 14 are adjusted so that the pair of shake compensation lens systems 8a, 8b is each driven in sync (FIG. 5, step S6). As a result, images compensated by the two shake compensation lens systems 8a, 8b can be sufficiently synchronized even when there are individual differences among lens actuators 10a, 10b or shake compensation lens systems 8a, 8b, and the accuracy of range finding to the observed object can be improved.

We have explained above a preferred embodiment of the invention, however several variations can be added to the above-described embodiment.

### EXPLANATION OF REFERENCE NUMERALS

1 binoculars
2 binocular body
4a, 4b objective lens systems
6a, 6b eyepiece lens systems
8a, 8b shake compensation lens systems
10a, 10b lens actuators
12 shake detection sensor
14 control device
16 laser light source
18 projection lens
20 splitting prism for light projection
20a half mirror surface
22 light receiving element
24 light receiving lens
26 light receiving splitting prism
26a half mirror surface
28 computing device
30 display device
32 range finding switch

1. Binoculars comprising: a binocular body;
a pair of objective lens systems;
a pair of eyepiece lens systems for respectively enlarging images formed by each of the pair of objective lenses;
a pair of shake compensation lens systems disposed on an optical path between the objective lens system and the eyepiece lens system, for respectively stabilizing images formed by each of the pair of objective lens systems;
a shake detection sensor for detecting vibration of the binocular body;
a first lens actuator for driving a first shake compensation lens system among the shake compensation lens systems, within a plane normal to an optical axis;
a second lens actuator for driving a second shake compensation lens system among the shake compensation lens systems, within a plane normal to an optical axis;
a control device configured to independently control the first and second lens actuators based on a detection signal from the shake detection sensor;
a laser light source for emitting laser light for range finding from the first objective lens system among the objective lens systems, via the first shake compensation lens system;
a light receiving element for receiving laser light emitted by the first objective lens system and reflected by an observed object via the second objective lens system among the objective lens systems, and via a second shake compensation lens system; and
a computing device configured to calculate a distance to the observed object based on laser light received by the light receiving element;
whereby the control device is configured to control the first and second lens actuators so that the positions in a vertical direction of images formed by each of the first and second objective lens systems are synchronized.

2. The binoculars of claim 1, whereby the control device is further configured to control the first and second lens actuators so that the positions in a horizontal direction of images formed by each of the first and second objective lens systems are synchronized.

3. The binoculars of claim 2, whereby the control device is further configured to control the first and second lens actuators so that a displacement of the first shake compensation lens system by the first lens actuator and a displacement of the second shake compensation lens system by the second lens actuator are approximately equal.

4. The binoculars of claim 1, whereby the control device comprises a memory for storing an adjustment table with adjustments to minimize the difference between the displacement of the first shake compensation lens system by the first lens actuator and the displacement of the second shake compensation lens system by the second lens actuator, and the first and second lens actuators are controlled by referring to said adjustment table.

5. The binoculars of claim 1, wherein the computing device is configured to calculate the distance to the observed object based on a phase difference between laser light emitted by the laser light source and laser light received by the light receiving element.

6. The binoculars of claim 1, wherein the first and second shake compensation lens systems are disposed at positions symmetrical to the shake detection sensor, on both sides of the shake detection sensor.

7. A method for manufacturing binoculars capable of measuring the distance to an observed object, comprising steps of:
a step for preparing a binocular body;
a step for attaching to the binocular body: a pair of objective lens systems, a pair of eyepiece lens systems, a pair of shake compensation lens systems, lens actuators to drive the shake compensation lens systems, a shake detection sensor, a control device for controlling the lens actuators, a laser light source for emitting laser light for range finding, a light receiving element for receiving laser light reflected by an observed object; and a computing device for calculating distance to the observed object based on received laser light;
a step for adjusting control parameters of the control device so that each of the pair of shake compensation lens systems is respectively each driven in sync; and
a step for storing adjusted control parameters in a memory of the control device.
